(19) United States
(12) Patent Application Publication
(10) Pub. No.: US 2010/0091686 A1
(43) Pub. Date: Apr. 15, 2010

(54) METHOD AND SYSTEM TO RESET A DEVICE OF A WIRELESS NETWORK AND WIRELESS NETWORK DEVICE

(75) Inventors: Alwin Rutjes, Ewijjk (NL); Jos Van Meurs, Veghel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,394

(22) PCT Filed: Dec. 17, 2007
(86) PCT No.: PCT/IB07/55151

§ 371 Date: Jun. 16, 2009

(30) Foreign Application Priority Data
Dec. 20, 2006 (EP) 06126674.8

(51) Int. Cl. H04L 12/28

(52) U.S. Cl. 370/254

(57) ABSTRACT

The invention relates to resetting devices of a wireless network, particularly wireless home control networks, for example lighting control networks in buildings. It is an object of the invention to provide an improved method and system to reset devices of a wireless network and an improved wireless network device. According to an embodiment of the invention, an all overruled reset signal (18) may be sent out by a wireless remote device (10); the all overruled reset signal (18) may be received by devices (14, 16) of the wireless network located within a predefined range (26) of the wireless remote device (10). A device (16), which received the all overruled reset signal, may be reset in that the device is set to factory defaults. Thus, wireless network devices may be reset without pushing a button on the devices.

The invention relates to resetting a device of a wireless network, particularly of a wireless home control network, for example a lighting control network in a building.

Wireless networks such as wireless home control networks are becoming more and more popular. The devices of these networks such as routers or wireless access points usually contain software and may be reset by pressing a button in order to get back to the “factory settings” of these devices. However, it may be difficult to reset by network devices in inaccessible locations or devices with special operating conditions such as hot lamps of a lighting system by pressing a button. Moreover, electric lamps of a complex lighting system often do not have at all a reset button because of the danger of electric shocks and of burnings due to the heat generated by an electric lamp. The document “Patent abstracts of Japan” JP 2003-059673, application number 2001-243097, discloses a remote controlled illumination unit which is automatically reset in order to get back the “factory settings” when a microcomputer of the remote controlled illumination unit is not in the state of a power-on reset as in the case of a non operability by a normal routine of the microcomputer. In other words, when the microcomputer stops operating, it is automatically reset by means of a watchdog timer.

It is an object of the invention to provide an improved method and system to reset devices of a wireless network and an improved wireless network device.

In order to achieve the object defined above, the invention provides a method to reset a device of a wireless network, wherein the method comprises the following characteristic features:

sending out an all overruled reset signal by a wireless remote device,

receiving the all overruled reset signal by devices of the wireless network located within a predefined range of the wireless remote device, and

resetting a device, which received the all overruled reset signal, in that the device is set to factory defaults.

It should be noted that the sending out of an all overruled reset signal is not limited to only a remote control, but also possible with other devices. Thus, the term “wireless remote device” comprises any device which is able to send out an all overruled reset signal in a wireless network.

In order to achieve the object defined above, the invention provides a system to reset a device of a wireless network, wherein the system comprises the following characteristic features:

a wireless remote device adapted to send out an all overruled reset signal,

at least one device of the wireless network adapted to receive the all overruled reset signal and to reset itself upon receipt of the all overruled reset signal in that it is set to factory defaults.

In order to achieve the object defined above, the invention further provides a wireless network device, particularly a wireless lighting device, wherein the device is adapted

to send out network discovery beacons during its startup,

to wait for a reply from a wireless network device, and

to reset itself if no reply has been received within a predefined time span after sending out a first network discovery beacon

The characteristic features according to the invention provide the advantage that a device of a wireless network, for example a lamp of a wireless lighting system, may be reset without pressing a button of the device. Therefore, the invention is particularly suitable to reset a device which is difficult or dangerous to directly touch such as a hot remote controlled (RC) lamp of a lighting system or a device in an inaccessible location. Also, no button for resetting the device is necessary and, thus, the invention allows to have an aesthetic design of a wireless network device such as a lamp design without any button. The invention is suitable for all wireless home control systems, especially for wireless lighting systems.

“Resetting a device” as used herein means to set a device, or a configuration of the device to factory defaults. The term “factory defaults” means the configuration of device when the device “leaves” the factory. For example, it may mean a certain standard configuration such as a set of predefined parameters of an embedded software of the device. The set of parameters may contain certain predefined standard networking settings such as a certain standard network address or the like. Thus, when a device is reset according to the invention, it is made “factory new”. The term “factory new” particularly means resetting the software of a device, i.e. a network part like it is a new part again.

The term “wireless” especially comprises radio transmission, for example according to the ZigBee™ standard, but it is not restricted to radio transmission. In principle, also other wireless transmission techniques such as light communication may be used with the invention.

An “all overruled reset signal” as used herein means a signal which has a high priority, i.e. overrules other signals for example for controlling the operation of a network device. The all overruled reset signal may be for example sent out by the wireless remote device at a higher output power than standard control signals, or it may comprise for example a flag indicating its high priority. The all overruled reset signal may be regarded as a kind of privileged signal which is handled preferential in a wireless network.

According to an embodiment of the invention, the all overruled reset signal may be sent out upon receipt of a predefined command by the wireless remote device. For example, the predefined command may be generated by pressing a certain button of the wireless remote device or entering a certain code in the wireless remote device. Thus, a user may comfortably reset devices of the wireless network by simply pressing a button on the wireless remote device or by entering a code in the wireless remote device, for example a combination of several buttons which were consecutively pressed.

The all overruled reset signal may be a kind of broadcast signal resetting all wireless network devices within a certain range of the wireless remote device which sends out the all overruled reset signal. However, according to an embodiment of the invention, the all overruled reset signal may be also prepared by selecting a certain device of the wireless network to be reset. In this case the all overruled reset signal is a kind of unicast signal sent from the wireless remote device to a selected device of the wireless network. Thus, a user may explicitly reset a certain device of the wireless network.

Particularly, according to a further embodiment of invention, the all overruled reset signal may contain an identifier of a device of the wireless network to be reset. The identifier may be for example a network address of the device to be reset, or it may be a network name in a wireless network such as “hanging lamp” or “lamp 1” or “wall light 2”. The device to be reset may be selected by a user by selecting this name, for example via a display of the wireless remote device showing the names of all devices in the wireless network and selecting the device to be reset over the display and by pressing a selection button.

According to an embodiment of the invention, the method may further comprise the following steps for detecting a device to be reset and to reset a detected device:

each device receiving the all overruled reset signal checks the identifier contained in the all overruled reset signal,

the device addressed with the identifier sends out a reply signal to the wireless remote device in order to signal that a reset procedure is initiated, and

the device resets itself.

For example, after selection of a device to be reset via the wireless remote device and sending out the all overruled reset signal, each device receiving the all overruled reset signal checks whether it is addressed. The addressed device sends the reply signal to the wireless remote device which may be displayed by the wireless remote device, for example by blinking light or by displaying a certain text message such as “Lamp 1 is being resetted . . . wait!”. This gives a user a better overview of the resetting procedure and allows the user to better control the wireless network.

The device may reset itself according to an embodiment of the invention by

resetting an internal memory containing operation parameters,

restarting itself,

detecting at startup that it has been reset, and

setting the factory defaults by loading a predefined set of operation parameters into the internal memory.

The predefined set of operational parameters may be stored for example in an internal ROM (Read Only Memory) of the device and typically comprise certain factory new operating parameters which may later be overwritten by a user, in case of a RC lamp for example the lighting intensity or the lighting color.

According to an embodiment of the invention, a computer program is provided, wherein the program is enabled to carry out the method according to the invention when executed by a computer. Furthermore, an embodiment of the invention provides a record carrier storing a computer program according to the invention.

According to a further embodiment of the invention, a computer programmed to perform a method according to the invention is provided, wherein the computer may comprise a wireless communication module adapted to prepare and send out an all overruled reset signal for resetting wireless network devices.

In the system according to an embodiment of invention, the wireless remote device may be configured to perform a method according to the invention. Furthermore, the system may be applied in a lighting system with plurality of wireless lighting devices controllable by a wireless remote lighting controller.

A further embodiment of the invention relates to a wireless remote device adapted to reset devices of a wireless network according to a method according to the invention and comprising

a controller configured to prepare an all overruled reset signal, and

a transceiver being controlled by the controller for sending out the all overruled reset signal.

The wireless remote device may be for example a wireless lighting controller with which a wireless lighting system may be controlled, such as switching lights on and off, dimming lights, and changing further parameters of the lighting system. The wireless lighting controller may be adapted to communicate with wireless lighting devices via radio frequency, particularly ZigBee™.

According to an embodiment of the invention, the wireless network device may further be adapted to periodically send out several network discovery beacons.

According to an embodiment of the invention, the device may stop the reset procedure if it receives a reply from a wireless network device within the predefined time span.

Finally, an embodiment of the invention relates to a wireless network device, particularly a wireless lighting device, which is adapted to be applied to a system according to the invention and to receive an all overruled reset signal and to reset itself upon receipt of the all overruled reset signal. For example, the wireless network device may be a RC lamp of a wireless lighting system. This wireless lighting system comprises a network of several RC lamps which may be controlled by wireless lighting controller such as specified before. However, the wireless network device may be any network device of a wireless home control network such as a wireless media server or any wireless household appliance.

These and other aspects of the invention will be apparent from and elucidated with reference to the embodiment(s) described hereinafter.

The invention will be described in more detail hereinafter with reference to exemplary embodiments. However, the invention is not limited to these exemplary embodiments.

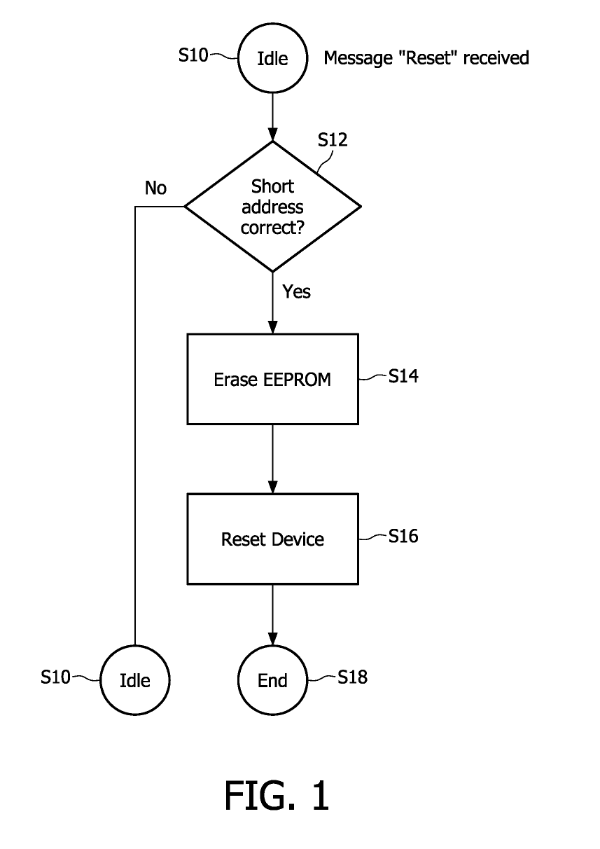

FIG. 1 shows a flowchart of a first embodiment of a method to reset devices of a wireless network according to the invention;

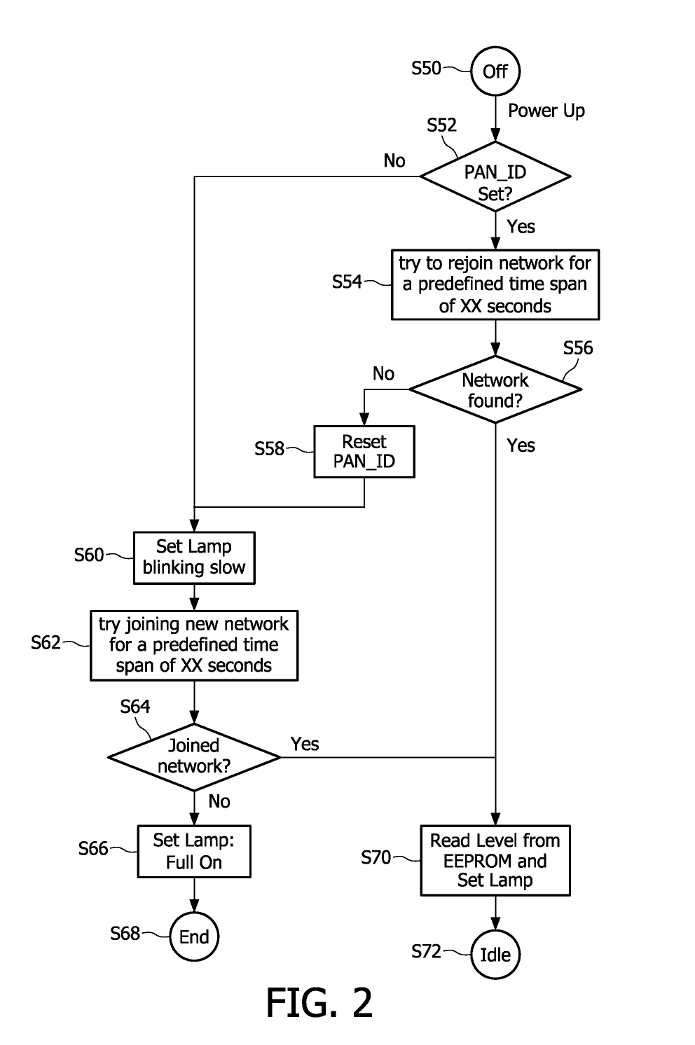

FIG. 2 shows a flowchart of a second embodiment of a method to reset devices of a wireless network according to the invention; and

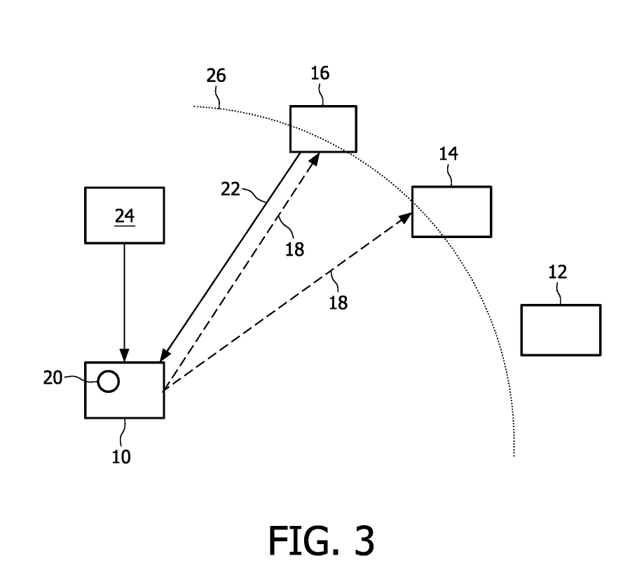

FIG. 3 an embodiment of a system to select devices of a wireless network according to the invention.

The invention will now be explained by means of an exemplary wireless home lighting control system. This lighting control system comprises a number of lighting devices which comprise RF communication means. The lighting devices are integrated in a wireless control network using for example ZigBee™ for communicating with a wireless remote device such as a wireless lighting remote controller. The invention now enables a user to reset certain lighting devices in the network only with the wireless lighting remote controller. The wireless lighting remote controller may be implemented for example as a separate device similar to the remote controller for a TV set, but it may also embodied in software which may be executed by a Personal Computer (PC) comprising a wireless communication module in order to be able to communicate with the wireless lighting devices.

FIG. 3 shows a block diagram of the wireless home lighting control system with the wireless lighting remote controller 10, three wireless lighting devices 12, 14, and 16, and a selection button 24 (also called “magic wand button” since it allows similar to a wand mounted selection button to select a certain lighting device). A certain wireless lighting device 12, 14, or 16, is selected via the selection button 24 and the wireless lighting remote controller 10. When a certain device 16 is selected, the wireless lighting remote controller 10 may send out an all overruled reset signal 18 upon pressing a button 20 of the controller 10 via its wireless RF communication module. The all overruled reset signal 18, which contains the network address of the selected wireless lighting device 16, is send out at a predefined output power, which determines the range of the devices to be reset. Typically, the output power is selected such that only devices with a short distance from the controller 10 may be reset. The range is intimated in FIG. 3 with the dotted line 26. In the shown situation, the wireless lighting device 12 is located outside the range 26 and, therefore, dos not receive the all overruled reset signal 18. The devices 14 and 16 located at the border of the range 26 however receive the all overruled reset signal 18 and start to check for the address contained in the all overruled reset signal. The device 16 detects that the all overruled reset signal 18 contains its network address and replies to the received all overruled reset signal 18 with a signal 22 containing a “leave” message signaling to the controller 10 that it will initiate the reset procedure. In the next step, device 16 will reset its internal EEPROM (Electrically Erasable Programmable Read Only Memory), which contains several operating parameters of the device 16, and restarts itself. At the startup, the device 16 will detect that it has been reset, and it will set the factory defaults by loading it from an internal ROM (Read Only Memory) in an internal EEPROM. Thus, the device 16 is reset to a “factory new” state.

FIG. 1 shows a flowchart of a reset procedure of a lamp after receipt of an all overruled reset signal from a wireless lighting remote controller 10 of a lighting system as shown in FIG. 3. The wireless lighting remote controller 10 selects the lamp with the magic wand feature. If the lamp is selected and a certain button of the controller 10 is pressed, the remote control sends an all overruled reset command to the lamp which contains the short address of the lamp as data. The lamp, which is in an idle state S10, receives the message and checks for the short address in the message if the message is really meant for it (step S12). If the short address is not correct, the lamp stays in the idle state S10, otherwise it will send out a “leave” message addressed to the controller 10. The “leave” message may be optically indicated by the controller 10, for example with a blinking LED or by displaying for example “lamp 10 resetting . . . ”. Then, the lamp will reset its EEPROM which contains certain operating parameters such as the light intensity or color in a step S14 and reset itself in a step S16. During the start-up procedure, the lamp will detect that it has been reset, and it will set the factory defaults (not shown in the flowchart).

FIG. 2 shows the reset procedure of lamp without using a wireless lighting remote controller. The reset procedure is initiated during the starting procedure, i.e. after power up. When a lamp, which is in an Off-state S50, is started (by turning on the mains), it first checks in a step S52 whether the PAN_ID, i.e. an identity of a Personal Area Network (PAN) is set in order to determine whether it is already a member of an existing wireless lighting control network. If the PAN_ID is set, the lamp will send out “network discovery” beacons on application level to search for its wireless lighting control network and to rejoin that network in a step S54. If the lamp finds an existing network (step S56), i.e. it gets a response from another device of its network, it will stop searching and read the intensity level from its EEPROM and set the lamp in a step S70. Then, the lamp is again in an idle state (step S72). If in step S56 no network is found, the lamp resets its PAN_ID (resetting its EEPROM) in a step S58 and continues with step S60 which is also entered if in step S52 the lamp detects that no PAN_ID is set. In step S60, the lamp blinks slowly in order to visually indicate the reset procedure and the procedure for joining a new network. In a following step S62, the lamp tries to join a new network for a predefined time span of XX seconds, for example for about 10 seconds. In this step S62, the lamp sends out the first “network discovery” beacon after a few seconds, and sends out further beacons after a pause of a few seconds. So it will keep searching for a network for a maximum of 10 seconds. In step S64 it is determined whether the lamp could join a new network during the time span of about 10 seconds, i.e. did or did not receive any responses from network devices to its sent out beacons. If the lamp received responses and, thus, could join a network, the procedure continues with step S70 (see above). Otherwise, the lamp sets itself to be switched fully on, i.e. to light with full intensity in a step S66. This indicates that the lamp has not joint any wireless lighting control network. In a following step S68, the procedure then ends.

The invention is suitable to reset a wireless network device without a pressing a button on the device which is much more comfortable than to use either a complex control software for programming for example a complex lighting system with a plurality of wireless lighting devices distributed in a large building or at least a large room or hall. Furthermore, reset buttons on wireless network devices may be saved. The invention is particularly suitable for application in modern lighting systems comprising a network of wireless lighting devices which may be controlled, i.e. switched on or off or dimmed by a wireless remote controller. However, the invention may be also applied to other networks such as home media networks, household appliances networks, and general home control networks.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. A method to reset a device (12, 14, 16) of a wireless network comprising the following steps:
sending out an all overruled reset signal (18) by a wireless remote device (10),
receiving the all overruled reset signal (18) by devices (14, 16) of the wireless network located within a predefined range (26) of the wireless remote device (10), and
resetting a device (16), which received the all overruled reset signal, in that the device is set to factory defaults.

2. The method of claim 1, wherein the all overruled reset signal is sent out upon receipt of a predefined command by the wireless remote device (10).

3. The method of claim 2, wherein the predefined command is generated by pressing a certain button of the wireless remote device (10) or entering a certain code in the wireless remote device (10).

4. The method of claim 1, wherein the all overruled reset signal (18) is prepared by selecting a certain device (16) of the wireless network to be reset.

5. The method of claim 4, wherein the all overruled reset signal (18) contains an identifier of a device (16) of the wireless network to be reset.

6. The method of claim 5, wherein
each device (14, 16) receiving the all overruled reset signal (18) checks the identifier contained in the all overruled reset signal,
the device (16) addressed with the identifier sends out a reply signal (22) to the wireless remote device (10) in order to signal that a reset procedure is initiated, and
the device (16) resets itself.

7. The method of claim 6, wherein the device (16) resets itself by
resetting an internal memory containing operation parameters (S14),
restarting itself (S16),
detecting at startup that it has been reset, and
setting the factory defaults by loading a predefined set of operation parameters into the internal memory.

8. A computer program enabled to carry out the method according to claim 1 when executed by a computer.

9. A record carrier storing a computer program according to claim 8.

10. A computer programmed to perform a method according to claim 1 and comprising a wireless communication module adapted to send out a all overruled reset signal to certain devices if the wireless network.

11. A system to reset devices of a wireless network comprising:
a wireless remote device (10) adapted to send out an all overruled reset signal (18),
at least one device (16) of the wireless network adapted to receive the all overruled reset signal (18) and to reset itself upon receipt of the all overruled reset signal in that it is set to factory defaults.

12. A system to reset devices of a wireless network comprising:
a wireless remote device (10) adapted to send out an all overruled reset signal (18),
at least one device (16) of the wireless network adapted to receive the all overruled reset signal (18) and to reset itself upon receipt of the all overruled reset signal in that it is set to factory defaults, configured to perform a method according to claim 1.

13. The system of claim 11, wherein it is applied in a lighting system with plurality of wireless lighting devices (12, 14, 16) controllable by a wireless remote lighting controller (10).

14. A wireless remote device (10) adapted to reset devices of a wireless network according to a method according to claim 1 and comprising
a controller configured to prepare an all overruled reset signal, and
a transceiver being controlled by the controller for sending out the all overruled reset signal.

15. A wireless network device (12, 14, 16), particularly a wireless lighting device, adapted
to send out network discovery beacons during its startup (S54),
to wait for a reply from a wireless network device (S56), and
to reset itself if no reply has been received within a predefined time span after sending out a first network discovery beacon.

16. The device of claim 15, wherein it is adapted to periodically send out several network discovery beacons.

17. The device of claim 15, wherein it is adapted to stop the reset procedure if it receives a reply from a wireless network device within the predefined time span.

18. A wireless network device (12, 14, 16), particularly a wireless lighting device, adapted
to send out network discovery beacons during its startup (S54),
to wait for a reply from a wireless network device (S56), and
to reset itself if no reply has been received within a predefined time span after sending out a first network discovery beacon, wherein it is adapted to be applied to a system according to claim 11 and to receive an all overruled reset signal and to reset itself upon receipt of the all overruled reset signal.
